(19) United States
(12) Patent Application Publication
(10) Pub. No.: US 2025/0073802 A1
(43) Pub. Date: Mar. 6, 2025

(54) SYSTEMS AND METHODS FOR UTILIZING DISCRETE INPUT CONTROLS FOR PUSH-PULL GUNS/TORCHES, SPOOL GUNS/TORCHES, MIG (GTAW) TORCHES, AND/OR TIG (GTAW) TORCHES

(71) Applicant: Illinois Tool Works Inc., Glenview, IL (US)

(72) Inventors: Mark R. Christopher, Neenah, WI (US); Adam Schmitz, Neenah, WI (US); Bo Zhang, Neenah, WI (US)

(21) Appl. No.: 18/814,109

(22) Filed: Aug. 23, 2024

Related U.S. Application Data
(60) Provisional application No. 63/535,954, filed on Aug. 31, 2023.

(51) Int. Cl. B23K 9/095

(52) U.S. Cl. CPC B23K 9/0953

(57) ABSTRACT

Systems and methods are provided for utilizing discrete input controls for push-pull guns/torches, spool guns/torches, MIG (GTAW) torches, and/or TIG (GTAW) torches. A welding-type torch configured for applying welds may include an input component configured for setting a welding-type parameter associated with a welding-type device that is used in conjunction with the welding-type torch during welding-type operations, with the input component configured to cause adjusting the welding-type parameter by a preset discrete value in response to each individual action on the input component by a user of the welding-type torch.

### CLAIM OF PRIORITY

This patent application claims priority to and claims benefit from U.S. Provisional Patent Application Ser. No. 63/535,954, filed on Aug. 31, 2023. The above identified application is hereby incorporated herein by reference in its entirety.

### BACKGROUND

Welding has become increasingly ubiquitous. Welding can be performed in an automated manner or in a manual manner (e.g., being performed by a human). During welding operations, welding parameters may be set or adjusted. However, conventional approaches for setting or adjusting welding parameters can be cumbersome and/or inefficient, costly. For example, setting welding parameters directly thorough welding equipment may require the users to move from welding location.

Limitations and disadvantages of conventional approaches will become apparent to one skilled in the art, through comparison of such approaches with some aspects of the present systems and methods set forth in the remainder of this disclosure with reference to the drawings.

### BRIEF SUMMARY

Aspects of the present disclosure relate to welding solutions. More specifically, various implementations in accordance with the present disclosure are directed to systems and methods for utilizing discrete input controls for push-pull guns/torches, spool guns/torches, MIG (GTAW) torches, and/or TIG (GTAW) torches, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 shows an example welding-type setup that may be used for welding-type operations, in accordance with aspects of this disclosure.

FIG. 2 shows an example welding setup with a torch that may be configured to support use of discrete input controls.

FIG. 3 illustrates an example torch with discrete input controls.

FIG. 4 illustrated an example input/output component for use in a torch with discrete input controls.

### DETAILED DESCRIPTION

As utilized herein, the terms “circuits” and “circuitry” refer to physical electronic components (e.g., hardware), and any software and/or firmware (“code”) that may configure the hardware, be executed by the hardware, and/or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may operate, for example, on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic component (e.g., hardware) and any software and/or firmware (“code”) that may configure the hardware, be executed by the hardware, and/or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

Welding-type power, as used herein, refers to power suitable for welding, plasma cutting, induction heating, CAC-A (carbon arc cutting/air) and/or hot wire welding/preheating (including laser welding and laser cladding). Welding-type power supply, as used herein, refers to a power supply that can provide welding-type power. A welding-type power supply may include power generation components (e.g., engines, generators, etc.) and/or power conversion circuitry to convert primary power (e.g., engine-driven power generation, mains power, etc.) to welding-type power.

Welding-type operations, as used herein, comprise operations in accordance with any known welding technique, including flame welding techniques such as oxy-fuel welding, electric welding techniques such as shielded metal arc welding (e.g., stick welding), metal inert gas (MIG) welding, tungsten inert gas (TIG) welding, resistance welding, as well as gouging (e.g., carbon arc gouging), cutting (e.g., plasma cutting), brazing, induction heating, soldering, and/or the like.

Welding-type setup, as used herein, refers to any setup comprising welding related devices or equipment (e.g., welding power sources, welding torch, welding gear such as headwear and the like, auxiliary devices or systems, etc.) which are used in facilitating and/or in conjunction with welding-type operations.

Welding-type parameter, as used herein, refers to any parameter or setting that pertains to or otherwise affects welding-type operations. Such Welding-type parameter may typically be applicable to or otherwise requires and adjusting at least one of the welding related devices or equipment (e.g., welding power sources, welding torch, welding gear such as headwear and the like, auxiliary devices or systems, etc.) which are used in facilitating and/or in conjunction with the welding-type operations

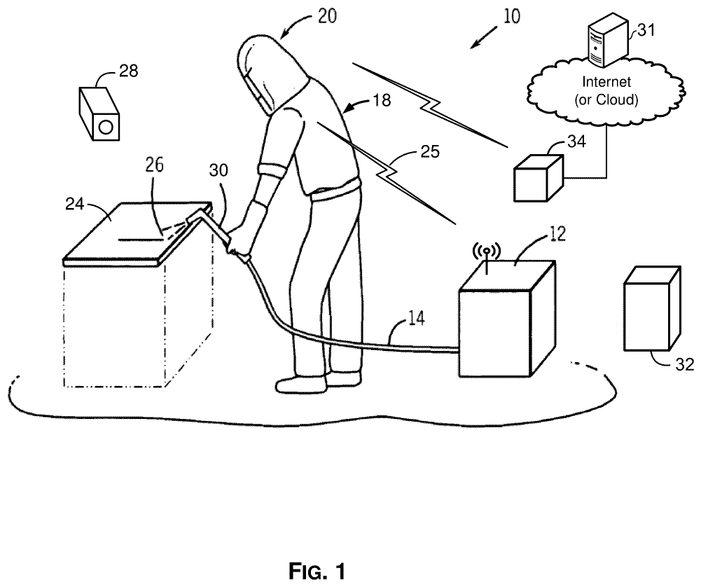

FIG. 1 shows an example welding-type setup that may be used for welding-type operations, in accordance with aspects of this disclosure.

Referring to FIG. 1, there is shown an example welding-type setup 10 in which an operator 18 is wearing welding headwear 20 and welding a workpiece 24 using a torch 30 to which power is delivered by equipment 12 via a conduit 14, with weld monitoring equipment 28, which may be available for use in monitoring welding operations. The equipment 12 may comprise a power source, optionally a source of a shield gas and, where wire/filler material is to be provided automatically, a wire feeder. Further, in some instances an engine 32 may be used to drive equipment or components used during welding operations. The engine 32 may comprise a gas engine or a liquefied petroleum (LP) engine. The engine 32 may drive generators, power sources, etc. used during welding operations.

The welding-type setup 10 of FIG. 1 may be configured to form a weld joint by any known welding-type technique. For example, optionally in any implementation, the welding equipment 12 may be arc welding equipment that provides a direct current (DC) or alternating current (AC) to a consumable or non-consumable electrode of a torch 30. The electrode delivers the current to the point of welding on the workpiece 24. In the welding-type setup 10, the operator 18 controls the location and operation of the electrode by manipulating the torch 30 and triggering the starting and stopping of the current flow. In other implementations, a robot or automated fixture may control the position of the electrode and/or may send operating parameters or trigger commands to the welding system. When current is flowing, an arc 26 is developed between the electrode and the workpiece 24. The conduit 14 and the electrode thus deliver current and voltage sufficient to create the electric arc 26 between the electrode and the workpiece. The arc 26 locally melts the workpiece 24 and welding wire or rod supplied to the weld joint (the electrode in the case of a consumable electrode or a separate wire or rod in the case of a non-consumable electrode) at the point of welding between electrode and the workpiece 24, thereby forming a weld joint when the metal cools.

Optionally in any implementation, the weld monitoring equipment 28 may be used to monitor welding operations. The weld monitoring equipment 28 may be used to monitor various aspects of welding operations, particularly in real-time (that is as welding is taking place). For example, the weld monitoring equipment 28 may be operable to monitor arc characteristics such as length, current, voltage, frequency, variation, and instability. Data obtained from the weld monitoring may be used (e.g., by the operator 18 and/or by an automated quality control system) to ensure proper welding.

As shown, the equipment 12 and headwear 20 may communicate via a link 25 via which the headwear 20 may control settings of the equipment 12 and/or the equipment 12 may provide information about its settings to the headwear 20. Although a wireless link is shown, the link may be wireless, wired, or optical.

Optionally in any implementation, equipment or components used during welding operations may be driven using engines. For example, the engine 32 may drive generators, power sources, etc. used during welding operations. In some instances, it may be desired to obtain information relating to used engines. For example, data relating to engines (and operations thereof) used during welding operations may be collected and used (e.g., based on analysis thereof) in monitoring and optimizing operations of these engines. The collection and use of such data may be performed telematically—that is, the data may be collected locally, subjected to at least some processing locally (e.g., formatting, etc.), and then may be communicated to remote management entities (e.g., centralized management locations, engine providers, etc.), using wireless technologies (e.g., cellular, satellite, etc.).

Optionally in any implementation, a dedicated controller (e.g., shown as element 34 in FIG. 1) may be used to control, centralize, and/or optimize data handling operations. The controller 34 may comprise suitable circuitry, hardware, software, or any combination thereof for use in performing various aspects of the engine related data handling operations. For example, the controller 34 may be operable to interface with the engine 32 to obtain data related thereto. The controller 34 may track or obtain welding related data (e.g., from weld monitoring equipment 28, from equipment 12, etc.). The controller 34 may then transmit the data (e.g., both engine related and weld related data), such as to facilitate remote monitoring and/or management, by way of wireless communications. This may be done using cellular and or satellite telematics hardware, for example.

In some example implementations, welding-type systems or setups, such as the welding-type setup 10, may be configured for collecting and reporting data relating to welding-type operations and/or to functions or components utilized during welding-type operations. For example, data from welding processes, power sources, welding-related accessories etc. in a weld setup may be collected. In this regard, the collected data may comprise, for example, current, voltage, wire feed speed, weld states, and numerous other power source parameters and settings.

The collected data may then be sent to remote entities (e.g., a remote server 31, which may be a manufacturer-controlled, Internet-based cloud server) and/or to local systems or devices (e.g., local PC, a tablet, a smartphone, etc.). The collected data may be utilized in enhancing welding-related systems and/or operations. For example, manufacturers may utilize the collected data to identify issues (and correct them) and/or devise modifications or improvements in the various components. Further, users may be able to generate reports on collected data to measure, document, and improve their processes.

Use of welding-type systems may pose some challenges and/or may have some limitations, however, and some of these challenges and/or limitations may vary for different welding techniques. For example, the distance between the power source (e.g., equipment 12) and the work site—that is, where the weld is being applied, such as the location of the workpiece—may create certain unique challenges or limitations. In this regard, such distances may create challenges with respect to operation, particularly when using certain types of torches. For example, in consumable based welding, such as MIG based welding, the distance the user may move without needing to re-position the power source may be long (e.g., ˜10 ft. or more). Such long distance (also referred to hereinafter as “lead”) may make conducting the welding operations, or at least aspects thereof, challenging. For example, certain welding-type parameters may be set or adjusted at the torch. The user may need to obtain information relating to these parameters (e.g., current values). In some instances, such information may be provided in the torch itself (e.g., via display or similar feedback components). However, often this is not done as it is desirable to keep torches as light and simple as possible, and adding a user interface (UI) therein, especially complex one, would result in added cost and complexity, while compromising rigidity as such user interface (UI) would be susceptible to damage in certain work conditions. Instead, the information is provided at the power source (e.g., equipment 12), which would require the user to physically move closer to the power source to obtain (e.g., read out) the information. This may not be desirable, especially in welding systems or setups that allow for long leads, and particularly where use of torch may require frequent setting or adjusting of particular welding-type parameters.

For example, in some instances push-pull and spool guns are used. In this regard, push-pull and spool guns are hand-held torches with motors that are built into them. The incorporation of motors into such torches may allow for long leads. The motor is used to help drive wire through the torch at a desired wire feed speed (WFS). The desired WFS may be typically controlled by control means (e.g., a rotational potentiometer or rotational encoder) mounted on the torch. This allows the operator to adjust wire feed speed (WFS) at the torch and not have to walk back to controller unit that is tethered to the torch, which has a user interface (which typically has WFS displayed). An issue with this control has been that it is hard to know exactly how much the wire feed speed is changing as you rotate the potentiometer (or encoder) unless you have a clear sightline back to a display on the user Interface. In recent years manufacturers have added small displays to the torch body to allow the users to see as the wire feed speed changes. Along with the display in many cases they have added Increase/decrease push buttons that increase or decrease the wire feed speed as a function of the amount of time they are pressed (activated). However, such displays add design complexity, add cost, and are not durable (e.g., not rugged enough, particularly in certain use conditions).

Solutions in accordance with the present disclosure may address such challenges and limitations. In this regard, embodiments based on the present disclosure may mitigate these issues by incorporating improved input controls that allow users to set or adjust certain welding-type parameters in a manner that may negate the need to physically move closer to the controller units without also requiring adding complex feedback components (e.g., user interface) at the torch. Such input controls may be configured to enable the operator to make discrete step changes to certain welding-type parameters, such as the wire feed speed (WFS), without a need for a display. For example, the use of such input controls may be analogous to trimming. In some instances, where a plurality of welding-type parameters may be set or adjusted, the input controls may be configured to enable switching among the welding-type parameters. Further, where a plurality of welding-type parameters may be set or adjusted via the input controls, the torch may incorporate simple feedback components to indicate which welding-type parameter is being set or adjusted.

Example embodiments and details related thereto are described in more detail. Nonetheless, while some of the embodiments described here are provided in the context of push-pull and spool guns, gas metal arc welding (GMAW) torches (e.g., metal inert gas (MIG) torches), and/or controlling wire feed speed (WFS) when using such torches, it should be understood that the disclosure is not limited to such torches and/or welding-type parameters, and as such implementations based on the present disclosure may be similarly used in any suitable welding-type torch and/or under all suitable conditions.

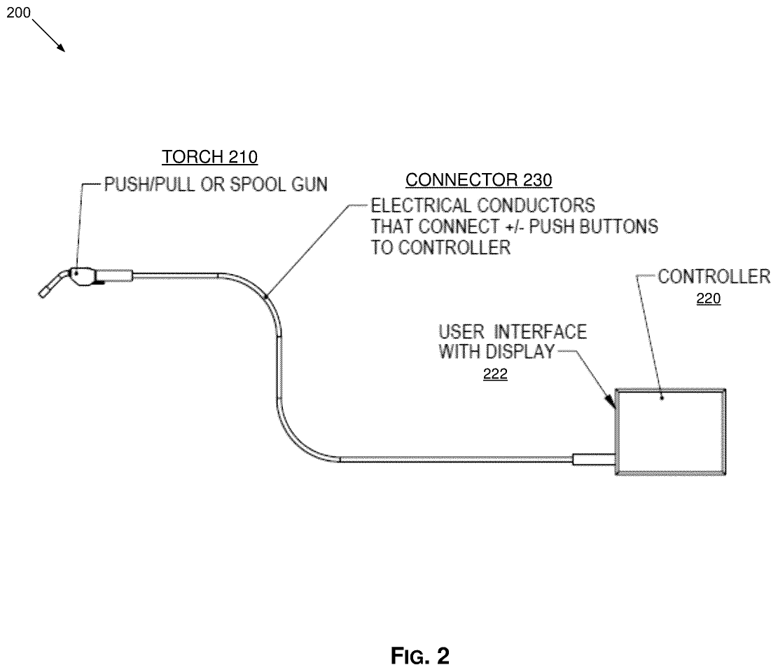

FIG. 2 shows an example welding setup with a torch that may be configured to support use of discrete input controls. Referring to FIG. 2, there is shown an example welding-type setup 200. In this regard, the welding-type setup 200 represents an example consumable (e.g., metal inert gas (MIG), metal active gas (MAG), etc.) based implementation of the welding-type setup 10 of FIG. 1. In particular, in the simplified illustration of such implementation that is depicted in FIG. 2, the welding-type setup 200 may comprise a welding torch (gun) 210, a controller unit 220, and a connector 230. Further, the controller unit 220 may comprise a user interface (UI) 222, which may incorporate suitable output devices (e.g., display) for providing information to the user.

In operation, the welding-type setup 200 may be used to apply consumable (e.g., MIG) based welds, such as to a workpiece (not shown). In this regard, during such welding operations, a consumable electrode wire is fed from a wire roll into the torch 210, as an electric arc is formed between the consumable electrode wire and the workpiece. The consumable electrode wire may be fed from the wire roll via the controller unit 220, such as through the connector 230, into the torch 210. In this regard, the wire roll may be incorporated into the controller unit 220, or may be coupled therewith. Alternatively, the consumable electrode wire may be fed from the wire roll via a separate connector (not shown). The electric arc may be formed as a current is applied to both of the torch 210 and the workpiece. The current may be supplied by a power supply unit, such as via the controller unit 220, through the connector 230. In this regard, the power supply unit may be a sub-component of the controller unit 220, or may be a separate physical unit that is coupled with the controller unit 220.

Once formed, the arc heats the workpiece metal(s) and the consumable electrode wire, causing them to melt and join, forming the weld. In some instances, a shielding gas may be applied to the weld area, such as to shield the weld from, e.g., atmospheric contamination. The shielding gas may be fed from a gas supply unit, such as via the controller unit 220 and the connector 230. In this regard, the gas supply unit may be a sub-component of the controller unit 220, or may be a separate physical unit that is coupled with the controller unit 220. Alternatively, the shielding gas may be provided from the gas supply unit via a separate connector (not shown). The torch 210 may be configured for supporting consumable based welding. In this regard, in some instances, the torch 210 may be a push-pull gun/torch, a spool gun/torch, a MIG (GTAW) torch, or a TIG (GTAW) torch. Some of these torches may be hand-held torches with motors that are built into them.

In some instances, the welding-type setup 200 may be configured in accordance with the present disclosure to address challenges and limitations that may arise with conventional solutions. In this regard, the welding-type setup 200 may allow for long leads to the work site, such as due to use of the push-pull or spool gun torch therein. However, as noted such long leads may make conducting the welding operations, or at least aspects thereof, challenging, in particular with respect to setting or adjusting some welding-type parameters, particularly where such welding-type parameters may be set or adjusted at the torch. In this regard, as noted the user may need to obtain information relating to such parameters (e.g., current values).

In conventional solutions, such information is provided via suitable feedback components, such as user interface (UI) and/or devices associated therewith (e.g., display). In this regard, while such UI (e.g., display) may be incorporated into the torch itself, this is not typically done such displays add design complexity, add cost, and are not durable (e.g., not rugged enough, particularly in certain use conditions). Instead, the information is provided at the power source (e.g., the controller unit 220). For example, as illustrated in FIG. 2, the controller unit 220 may incorporate a user interface (UI) 222, which may comprise suitable output devices (e.g., display) for providing information to the user. Use of the UI 222 in the controller unit 220, however, requires the user to physically move closer to the controller unit 220 to obtain (e.g., read out) the information. This may not be desirable, especially in welding systems or setups that allow for long leads, and particularly where use of torch may require frequent setting or adjusting of particular welding-type parameters.

Accordingly, the welding-type setup 200 may be modified to incorporate solutions based on the present disclosure, to address such challenges and limitations that may arise with conventional solutions. For example, the torch 210 may be modified to incorporate input controls that allow for setting or adjusting one or more welding-type parameters in the manner that obviate the need to use (at least frequently) the UI 222 of the controller unit 220, without requiring adding any complex UI components in the torch itself. In this regard, such input controls may be configured, e.g., to enable the operator to make discrete step changes to certain welding-type parameters, such as the wire feed speed (WFS), without a need for a display, thus obviating the need to move closer to controller unit 220 (to read out the information from the UI 222) or to add a display at the torch. In this regard, such input control may be configured to apply the same (predefined) adjustment in response to particular action event, without any dependency on the duration of the event. For example, where the action even is pressing a button, the adjustment would be same no matter how long (or short) the user pressed the button. As such, use of such input controls may be analogous to trimming. Further, in instances where multiple welding-type parameters may be set or adjust via these input controls, rather than add additional input controls (for each of the parameters), the input controls may be configured to enable switching (e.g., toggling) among such welding-type parameters.

In some instances, the input controls may be configured for setting a primary welding-type parameter, and to default back to that primary welding-type parameter after switching to another welding-type parameter.

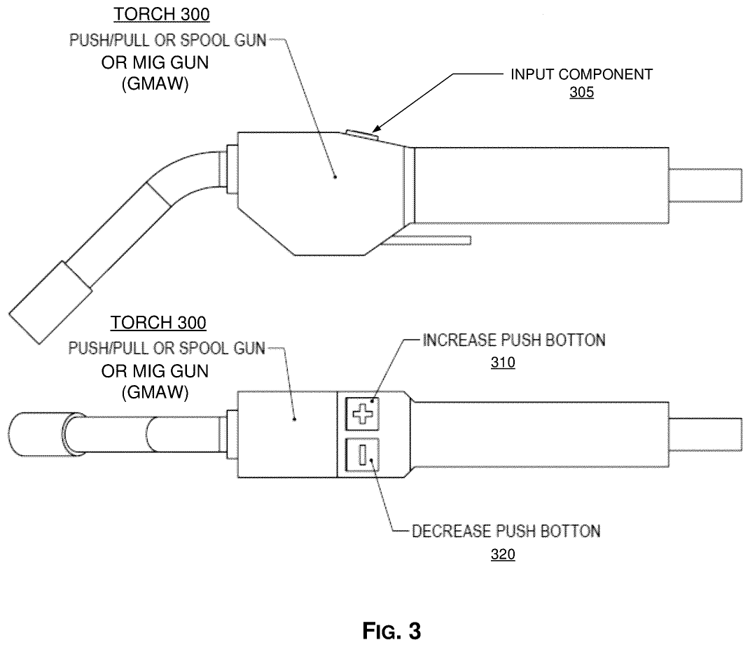

In one example embodiment, the input controls may comprise an increase input element and a decrease input element, which may be used to make, respectively, discrete increase adjustment and discrete decrease adjustment. These adjustments may be applied to particular welding-type parameters. Further, where multiple welding-type parameters may be set or adjust at the torch, these two input elements may be configured to enable switching among the parameters, such as by applying the same action (e.g., pressing) to both controls at the same time. For example, two momentary push buttons (increase (+) button and decrease (−) button) may be mounted on the torch. Such example embodiment is illustrated and described in more detail with respect to FIG. 3.

The increase (+) button and decrease (−) button may be used to set and adjust at least one welding-type parameters. In this regard, in many instances these buttons may be used to set or adjust wire feed speed (WFS); nonetheless, these buttons also may be used to adjust other parameters such as voltage, amperage, arc length, pulse frequency, and gas flow, etc. The two push buttons (increase (+) button and decrease (−) button) may be electrically connected to the controller unit 222, such as via the connector 230.

Thus, when there is an action on the increase (+) button by the user (e.g., the increase (+) button is pressed and released) the controller unit 222 will receive a single pulse. After receiving a pulse, the controller unit 222 applies an adjustment, such as by applying a predetermined increase to the welding-type parameters (e.g., adding predetermined amount of speed to the motor, to increase the speed and thus WFS) no matter how long the push button is held down when pressed. The increase would be of the same predetermined amount no matter how long the increase (+) button is held down pressed. Similarly, an action on the decrease (−) button by the user would be handled in the same manner, with the controller unit 222 applying a predetermined decrease to the welding-type parameters (e.g., subtract a predetermined amount of speed to the motor, to decrease the speed and thus WFS) no matter how long the push button is held down when pressed. The action may be repeated to achieve a particular adjustment. For example, if torch is configured so that each increase button press will result in an increase a WFS increase of 5 ipm (inches per minute) the user can press the increase push button four times if he wants to increase WFS by 20 ipm.

In some instances, the predetermined increment may be configurable and/or adjustable. In this regard, the user may be able set or adjust an increment (e.g., increase increment, decrease increment, or both) per individual action (e.g., push button press) for one or more supported welding-type parameters (e.g., WFS, voltage, etc.), such as via the UI 222 of the controller unit 220. For example, the user may change the WFS increment from 5 ipm per push button press to 10 ipm per push button press by changing this value via the user interface.

Use of such input controls—that is, controls that cause discrete changes—obviate the need for complex UI at the torch or use of the UI at the controller unit 200. In this regard, since the controller unit 222 only registers a pulse change and not length of the pulse the operator may make specific incremental changes to a welding-type parameter without the need for a display.

As noted, in some instances, the input controls may be used to set or adjust multiple welding-type parameters, and in some implementation, the same input controls are used for switching among those parameters. As such, in the two momentary push buttons (increase (+) button and decrease (−) button) may be used to switch (e.g., toggle) between different welding-type parameters, such as WFS and voltage. For example, this may be done by applying the same action (e.g., pressing and then releasing after hold time) both buttons at the same. The switching may be done in any suitable manner. For example, in some instances, when switching (e.g., toggling) between different welding-type parameters, the user may need to sequentially go through all supported parameters, such as to return to particular one. Alternatively, a particular welding-type parameter (e.g., WFS) may be set or selected as primary parameter, and such the input control may default back to the primary parameter after being used to switch to another parameter (and to adjust the value thereof).

In some instances, as noted, simple feedback elements (e.g., light-emitting diode (LED) indicators) may also be added to the torch, to provide simple and minimal feedback at the torch. In this regard, any suitable feedback mechanism (e.g., other types of visual indicators, audible indicators, tactile indicators, haptic indicators, etc.) may be used. The feedback elements may be used to provide, e.g., confirmation feedback, such as to acknowledge when an input control (e.g., push button) is acted upon by the user. For example, where LED indicator(s) are used, the LED may flash when the user makes an adjustment to particular welding-type parameter. In instances where multiple welding-type parameters may be set or adjust, the feedback elements may be configured to indicate which welding-type parameter is being set or adjusted. This may be done by adding indicator for each supported parameter, or by using at least one indicator to provide feedback uniquely identifying different parameters, such as by operating differently—e.g., remaining lit for one parameter while flashing or not getting lit for another parameter.

In some instances, simple feedback elements (e.g., light-emitting diode (LED) indicators) may also be added to the torch, to provide simple and minimal feedback at the torch, without adding significant cost or complexity, and without degrading the rigidity of the torch. In instances where multiple welding-type parameters may be set or adjust, the feedback elements may be configured to indicate which welding-type parameter is being set or adjusted.

FIG. 3 illustrates an example torch with discrete input controls. Shown in FIG. 3 is a welding-type torch 300, which may be configured for use of discrete input controls. As illustrated in FIG. 3, the torch 300 is a push-pull or spool gun based torch, and may represent an example implementation of the torch 210 as described with respect to FIG. 2, when configured for use of discrete input controls. Nonetheless, other types of torches, such as MIG (GTAW) torches, or a TIG (GTAW) torches may also be used. In this regard, the torch 300 may incorporate an input component 305 which may be configured for said welding-type torch comprises an input component 305 configured for setting one or more welding-type parameters, which may be associated with and/or pertains to configuration or operation of a welding-type device or component, external to and separate from the torch 300, which is used in conjunction with the torch 300 during welding-type operations. The input component 305 is configured to cause adjusting said welding-type parameter by a preset discrete value in response to each individual action on said input component 305 by a user of said welding-type torch.

For example, as illustrated in FIG. 3, the input component 300 may comprise an increase push button 310 and a decrease push button 320, which may be configured to facilitate applying, respectively, to a particular welding-type parameter an increase by a preset discrete value and a decrease by a preset decrease value. In this regard, the preset discrete increase value and the preset discrete decrease value may have the same absolute value (e.g., an increase value of 10 and a decrease value of 10 of the same applicable unit). For example, when used to adjust the wire feed speed (WFS), each action by the user on the increase push button 310 and the decrease push button 320 results in, respectively, an increase to the WFS by 5 iteration per minute (ipm) and a decrease to the WFS by 5 iteration per minute (ipm).

Alternatively, the preset discrete increase value and the preset discrete decrease value. In some instances, one or both of the preset discrete increase value and the preset discrete decrease value may be configurable and/or modifiable, such as by the user. For example, the preset discrete increase value and/or the preset discrete decrease value for one or more welding-type parameters adjustable at the torch may be set or adjusted, such as the equipment (e.g., the controller unit 220). This may be done, e.g., via the user interface (or any suitable input component) at the equipment. Alternatively (or additionally), at least some of the preset values may be predefined and loaded (e.g., as part of a welding profile or scheduled) used during the welding operations.

In some instances, in adding to simply applying preset adjustments, the increase push button 310 and the decrease push button 320 may be configured to facilitate and/or support other input functions. For example, as described herein, when a plurality of welding-type parameters can be set or adjusted using the increase push button 310 and the decrease push button 320, these buttons may be configured to enable switching (or toggling) among these parameters. For example, the operator may toggle between setting/adjusting the WFS and another parameter (e.g., voltage) by applying an action to (e.g., pressing down on) the increase push button 310 and the decrease push button 320 at the same time.

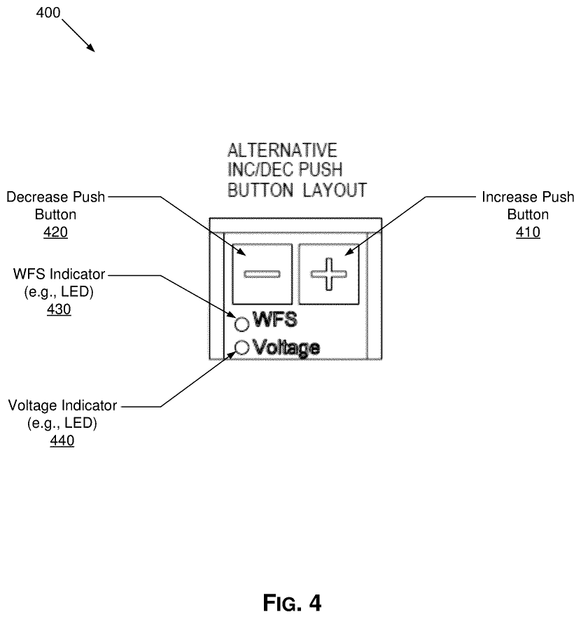

FIG. 4 illustrates an example input/output component for use in a torch with discrete input controls. Shown in FIG. 4 is a combined input/output component 400, illustrating an example layout that may be used in torch configured in accordance with an example embodiment based on the present disclosure.

The input/output component 400 may be configured for use in a torch (e.g., the torch 210 or the torch 300) to enable or support use of discrete inputs during welding operations, while also providing output (feedback), relating to, e.g., input controls and/or functions. For example, as illustrated in FIG. 4, the input/output component 400 comprises increase push button 410 and a decrease push button 420, which are substantially similar to and operate in substantially similar manner as the increase push button 310 and the decrease push button 320 described above. In addition, the input/output component 400 comprises a wire feed speed (WFS) indicator 430 and a voltage indicator 440. In this regard, as shown each of the WFS indicator 430 and the voltage indicator 440 may be a light-emitting diode (LED) indicator. However, it should be understood that the disclosure is not limited to such implementation, and as such any suitable feedback mechanism (e.g., other types of visual indicators, audible indicators, tactile indicators, haptic indicators, etc.) may be used.

Further, while input/output component 400 is illustrated as incorporating only the WFS indicator 430 and the voltage indicator 440, it should be understood that the disclosure is not so limited, and that in other implementations additional indicators may be used (e.g., where the input controls allow for setting or adjusting other welding-types parameters). Similarly, where the input controls are configured to set only one welding-type parameter (e.g., the WFS), only one indicator (e.g., the WFS indicator 430) may be used.

In some instances, the number of output elements (indicators) may not be the same as (e.g., be less than) the number of welding-type parameters that may be set or adjusted using the input controls. For example, with reference to the embodiment illustrated in FIG. 4, which may represents an implementation where the welding-type parameters that may be set or adjust (via the increase push button 410 and the decrease push button 420) are WFS and voltage, rather than using two indictors (the WFS indicator 430 and the voltage indicator 440) as shown, a single indicator (e.g., LED) may be used. In this regard, the single indicator (LED) may be configured to operate in different manner to indicate which welding-type parameter is be set or adjusted. The single indicator (LED) may be configured, e.g., such that it would be lit when setting or adjusting the WFS, and to not be lit (or turn off) or blink when the voltage is being set or adjusted. In other words, rather than having dedicating indicator for welding-type parameter that may be set or adjusted, one or more output elements (indicators) may be configured such that they would be used in providing indication(s) relating to multiple welding-type parameters.

An example welding-type system, in accordance with the present disclosure, comprises a welding-type torch configured for applying welds; and a welding-type controller configured for operation in conjunction with the welding-type torch during welding-type operations; wherein the welding-type torch comprises an input component configured for setting a welding-type parameter; the welding-type parameter is associated with or pertains to configuration or operation of the welding-type controller or another welding-type device used during the welding-type operations; and the input component is configured to cause adjusting the welding-type parameter by a preset discrete value in response to each individual action on the input component by a user of the welding-type torch.

In an example embodiment, the welding-type parameter comprises at least one of wire feed speed (WFS), voltage, amperage, arc length, pulse frequency, and gas flow.

In an example embodiment, the input component is configured to enable switching between different ones of a plurality of welding-type parameters.

In an example embodiment, the input component is configured for setting a primary welding-type parameter, and to default back to the primary welding-type parameter after switching to another welding-type parameter.

In an example embodiment, the primary welding-type parameter is wire feed speed (WFS).

In an example embodiment, the input component comprises at least a first input element and a second input element, wherein the first input element is configured to cause a positive discrete value adjustment to the welding-type parameter, and wherein the second input element is configured to cause a negative discrete value adjustment to the welding-type parameter.

In an example embodiment, the input component is configured such that a concurrent action on both of the first input element and the second input element causes switching between different welding-type parameters.

In an example embodiment, the welding-type torch comprises one or more output elements configured for indicating or identifying the welding-type parameter.

In an example embodiment, the welding-type torch comprises one or more feedback elements configured for providing feedback to confirm reception and application of adjustments to the welding-type parameter.

In an example embodiment, the welding-type torch comprises a push-pull gun/torch, a spool gun/torch, a MIG (GTAW) torch, or a TIG (GTAW) torch.

An example welding-type system, in accordance with the present disclosure, comprises a welding-type torch configured for applying welds; wherein the welding-type torch comprises an input component configured for setting a welding-type parameter associated with a welding-type device that is used in conjunction with the welding-type torch during welding-type operations; and wherein the input component is configured to cause adjusting the welding-type parameter by a preset discrete value in response to each individual action on the input component by a user of the welding-type torch.

In an example embodiment, the welding-type parameter comprises at least one of wire feed speed (WFS), voltage, amperage, arc length, pulse frequency, and gas flow.

In an example embodiment, the input component is configured to enable switching between different ones of a plurality of welding-type parameters.

In an example embodiment, the input component is configured for setting a primary welding-type parameter, and to default back to the primary welding-type parameter after switching to another welding-type parameter.

In an example embodiment, the primary welding-type parameter is wire feed speed (WFS).

In an example embodiment, the input component comprises at least a first input element and a second input element, wherein the first input element is configured to cause a positive discrete value adjustment to the welding-type parameter, and wherein the second input element is configured to cause a negative discrete value adjustment to the welding-type parameter.

In an example embodiment, the input component is configured such that a concurrent action on both of the first input element and the second input element causes switching between different welding-type parameters.

In an example embodiment, the welding-type torch comprises one or more output elements configured for indicating or identifying the welding-type parameter.

In an example embodiment, the welding-type torch comprises one or more feedback elements configured for providing feedback to confirm reception and application of adjustments to the welding-type parameter.

In an example embodiment, the welding-type torch comprises a push-pull gun/torch, a spool gun/torch, a MIG (GTAW) torch, or a TIG (GTAW) torch.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A welding-type system, comprising:
a welding-type torch configured for applying welds; and
a welding-type controller configured for operation in conjunction with said welding-type torch during welding-type operations;
wherein:
said welding-type torch comprises an input component configured for setting a welding-type parameter;
said welding-type parameter is associated with or pertains to configuration or operation of said welding-type controller or another welding-type device used during said welding-type operations; and
said input component is configured to cause adjusting said welding-type parameter by a preset discrete value in response to each individual action on said input component by a user of said welding-type torch.

2. The welding-type system of claim 1, wherein said welding-type parameter comprises at least one of: wire feed speed (WFS), voltage, amperage, arc length, pulse frequency, and gas flow.

3. The welding-type system of claim 1, wherein said input component is configured to enable switching between different ones of a plurality of welding-type parameters.

4. The welding-type system of claim 1, wherein said input component is configured for setting a primary welding-type parameter, and to default back to said primary welding-type parameter after switching to another welding-type parameter.

5. The welding-type system of claim 4, wherein said primary welding-type parameter is wire feed speed (WFS).

6. The welding-type system of claim 1, wherein said input component comprises at least a first input element and a second input element, wherein said first input element is configured to cause a positive discrete value adjustment to said welding-type parameter, and wherein said second input element is configured to cause a negative discrete value adjustment to said welding-type parameter.

7. The welding-type system of claim 6, wherein said input component is configured such that a concurrent action on both of said first input element and said second input element causes switching between different welding-type parameters.

8. The welding-type system of claim 1, wherein said welding-type torch comprises one or more output elements configured for indicating or identifying said welding-type parameter.

9. The welding-type system of claim 1, wherein said welding-type torch comprises one or more feedback elements configured for providing feedback to confirm reception and application of adjustments to said welding-type parameter.

10. The welding-type system of claim 1, wherein said welding-type torch comprises a push-pull gun/torch, a spool gun/torch, a MIG (GTAW) torch, or a TIG (GTAW) torch.

11. A welding-type system, comprising:
a welding-type torch configured for applying welds;
wherein said welding-type torch comprises an input component configured for setting a welding-type parameter associated with a welding-type device that is used in conjunction with said welding-type torch during welding-type operations; and
wherein said input component is configured to cause adjusting said welding-type parameter by a preset discrete value in response to each individual action on said input component by a user of said welding-type torch.

12. The welding-type system of claim 11, wherein said welding-type parameter comprises at least one of: wire feed speed (WFS), voltage, amperage, arc length, pulse frequency, and gas flow.

13. The welding-type system of claim 11, wherein said input component is configured to enable switching between different ones of a plurality of welding-type parameters.

14. The welding-type system of claim 11, wherein said input component is configured for setting a primary welding-type parameter, and to default back to said primary welding-type parameter after switching to another welding-type parameter.

15. The welding-type system of claim 14, wherein said primary welding-type parameter is wire feed speed (WFS).

16. The welding-type system of claim 11, wherein said input component comprises at least a first input element and a second input element, wherein said first input element is configured to cause a positive discrete value adjustment to said welding-type parameter, and wherein said second input element is configured to cause a negative discrete value adjustment to said welding-type parameter.

17. The welding-type system of claim 16, wherein said input component is configured such that a concurrent action on both of said first input element and said second input element causes switching between different welding-type parameters.

18. The welding-type system of claim 11, wherein said welding-type torch comprises one or more output elements configured for indicating or identifying said welding-type parameter.

19. The welding-type system of claim 11, wherein said welding-type torch comprises one or more feedback elements configured for providing feedback to confirm reception and application of adjustments to said welding-type parameter.

20. The welding-type system of claim 11, wherein said welding-type torch comprises a push-pull gun/torch, a spool gun/torch, a MIG (GTAW) torch, or a TIG (GTAW) torch.
